(19) United States
(12) Patent Application Publication
(10) Pub. No.: US 2014/0198229 A1
(43) Pub. Date: Jul. 17, 2014

(54) IMAGE PICKUP APPARATUS, REMOTE CONTROL APPARATUS, AND METHODS OF CONTROLLING IMAGE PICKUP APPARATUS AND REMOTE CONTROL APPARATUS

(71) Applicant: CANON KABUSHIKI KAISHA, Tokyo (JP)

(72) Inventor: Yosuke Morimoto, Yokohama-shi (JP)

(73) Assignee: CANON KABUSHIKI KAISHA, Tokyo (JP)

(21) Appl. No.: 14/153,234

(22) Filed: Jan. 13, 2014

(30) Foreign Application Priority Data
Jan. 17, 2013 (JP) 2013-005840

(51) Int. Cl. H04N 5/232; H04N 5/235

(52) U.S. Cl. CPC H04N 5/23203; H04N 5/23293; H04N 5/23212; H04N 5/2353
USPC 348/211.8

(57) ABSTRACT

An image pickup apparatus includes an image pickup device which generates an image signal by performing photoelectric conversion on an optical image via an optical system, an object detector which detects a plurality of object images based on the image signal obtained from the image pickup device, an identification information generator which allocates identification information to each of the object images, a communicator which sends the image signal and the identification information allocated to each of the object images to an outside of the image pickup apparatus, wherein the communicator is capable of receiving identification information of an object image relating to the sent identification information of the object image, and a controller configured to specify a main object image among the object images detected by the object detector based on the received identification information.

### BACKGROUND OF THE INVENTION

1. Field of the Invention

The present invention relates a control of a remote control system of an image pickup apparatus including the image pickup apparatus and a remote control terminal which externally operates the image pickup apparatus.

2. Description of the Related Art

Japanese Patent Laid-open No. 2009-273033 discloses a camera system including a camera 2 and a controller 1 which can externally control the camera 2. In such camera system, by an operator operating the controller 1, the focus position and photometric position can be set (specified) at the position of an intended subject while observing shot image data sent from the camera 2. At such setting, the controller 1 sends information relating to the set position of the subject to the camera 2. Thereby, the camera 2 can execute AF processing and the like at the position of the intended subject on the basis of the received position information.

However, in the above described conventional art, there has been a problem that the AF and AE controls are performed with respect to an object different from the specified object when an operator attempts to perform the AF and AE controls with respect to an object which is moving, such as a moving person. Hereinafter, this problem will be described with reference to FIGS. 5A to 5D.

FIGS. 5A to 5D are images which are shot by the camera 2 and an image which is displayed in the controller 1. FIGS. 5A, 5B and 5C on the left side are images in the camera 2 at the time t1, t2 and t3, respectively, and time elapses in the order of time t1, t2, and t3. FIG. 5D on the right side is an image in the controller 1 at the time t2.

In the display of the controller 1, a real time video image is sent from the camera 2 through a wireless or cabled communicator. However, since data amount of image data is large, a delay occurs in the time until the video image which is shot by the camera 2 is to be displayed on the display of the controller 1 through communication. This delay is caused by the time needed for data communication and the time for compressing image data in the camera 2 to reduce communication data amount and restoring the compressed data in the controller 1, etc.

An operation under the conventional art when there is a delay in image data communication will be described with reference to FIGS. 5A to 5D. FIG. 5A is an image shot by the camera 2 at the time of time t1, and a person 501 and a background 502 is included. Because the delay occurs between sending of the image of FIG. 5A to the controller 1 and displaying of the image, this image is to be displayed in the controller at the time of time t2 (FIG. 5B). An operator specifies the part of the person 501 in the screen of FIG. 5D with a finger 504 in the touch panel and thereby attempts to command the camera 2 to perform the AF and AE controls with respect to the person 501. The controller 1 detects the touched position and decides the target region 503 indicated by dotted lines which is the target for the AF and AE controls. The controller 1 further sends the position information of the target region 503 and a control command to instruct performing the AF and AE controls with respect to the target region 503 to the camera 2. Then, at the time of time t3, the camera 2 receives the position information of the target region 503 and the control command, and the camera 2 executes the AF and AE controls with respect to the target region 503.

However, if the person 501 has moved from the right side to the left side in the screen as illustrated in FIGS. 5A, 5B, and 5C in this order, only the background 502 is included in the target region 503 which is the target for the AF and AE controls at the time of time t3 and the person 501 is outside of the target region. Therefore, the AF and AE controls are to be executed with respect to the background 502 instead of the person 501.

Due to the communication delay between the camera 2 and the controller 1, in the conventional art, there has been a problem that the AF and AE controls are executed with respect to an object different from the object targeted by an operator because the region to perform the AF and AE controls cannot be specified accurately with respect to a moving object.

### BRIEF SUMMARY OF THE INVENTION

The present invention provides an image pickup apparatus, a remote control apparatus, a method of controlling the image pickup apparatus, and a method of controlling the remote control apparatus which are advantageous to an image pickup control even when a communication delay occurs between the image pickup apparatus and the communication apparatus.

An image pickup apparatus as one aspect of the present invention is adapted to be used with remote control apparatus external to the image pickup apparatus, and the image pickup apparatus includes an image pickup device configured to generate an image signal by performing photoelectric conversion on an optical image, an object detector configured to detect a plurality of objects based on the image signal generated by the image pickup device, an identification information generator configured to allocate identification information to each of the objects detected by the object detector, a communicator operable to send the image signal or another signal generated by the image pickup device and the identification information allocated to each of the objects by the identification information generator to the remote control apparatus, and also operable to receive identification information of an object specified by a user from among the objects for which identification information has been sent to the remote control apparatus, and a controller operable, based on the received identification information, to specify a target object among the objects detected by the object detector.

A remote control apparatus as another aspect of the present invention is adapted to be used with an image pickup apparatus external to the remote control apparatus, and the remote control apparatus includes a communicator operable to receive an image signal representing an image picked up by the image pickup apparatus and identification information allocated by the image pickup apparatus to each of a plurality of objects detected in the image, a display unit configured to display an image based on the received image signal, and a controller configured to provide identification information of a target object specified by a user of the remote control apparatus based on the displayed image from among the objects for which identification information has been received by the communicator, wherein the communicator is further operable to send the identification information of the target object provided by the controller.

A method of controlling an image pickup apparatus as another aspect of the present invention is adapted to be used with remote control apparatus external to the image pickup apparatus, and the method includes an image signal generating step of generating an image signal by performing photoelectric conversion on an optical image, an object detecting step of detecting a plurality of objects based on the image signal generated in the image signal generating step, an identification information generating step of allocating identification information to each of the objects detected in the object detecting step, a sending step of sending the image signal or another signal generated by an image pickup device and the identification information allocated to each of the objects in the identification information generating step to the remote control apparatus, a receiving step of receiving identification information of a target object specified by a user from among the objects for which identification information has been sent to the remote control apparatus, and a specifying step of specifying, based on the received identification information, a target object among the objects detected in the object detecting step.

A method of controlling a remote control apparatus as another aspect of the present invention is adapted to be used with remote control apparatus external to the image pickup apparatus, and the method includes a receiving step of receiving an image signal representing an image picked up by the image pickup apparatus and identification information allocated by the image pickup apparatus to each of a plurality of objects detected in the image, a displaying step of displaying an image based on the received image signal, a controlling step of providing identification information of a target object specified by a user of the remote control apparatus based on the displayed image from among the objects for which identification information has been received in the receiving step, and a sending step of sending the identification information of the target object provided by the controlling step.

Further features of the present invention will become apparent from the following description of exemplary embodiments (with reference to the attached drawings).

### BRIEF DESCRIPTION OF THE DRAWINGS

FIG. 1 is a block diagram illustrating a configuration of a camera body 101 and a remote control terminal 102 in an embodiment of the present invention.

FIGS. 2A to 2D are diagrams for use in explaining controls of object detecting, identification information setting, and object tracking in the camera body 101 in the embodiment of the present invention.

FIGS. 3A to 3F are diagrams for use in explaining a determining process of object identifying information performed in the remote control terminal 102 in the embodiment of the present invention.

FIGS. 4A and 4B are flowcharts illustrating specification process operation of an AF and AE control region in communication between the camera body 101 and the remote control terminal 102 in the embodiment of the present invention.

FIGS. 5A to 5D are diagrams illustrating a false operation of an AF and AE control region specification in a case where an object is moving in a conventional art.

### DESCRIPTION OF THE EMBODIMENTS

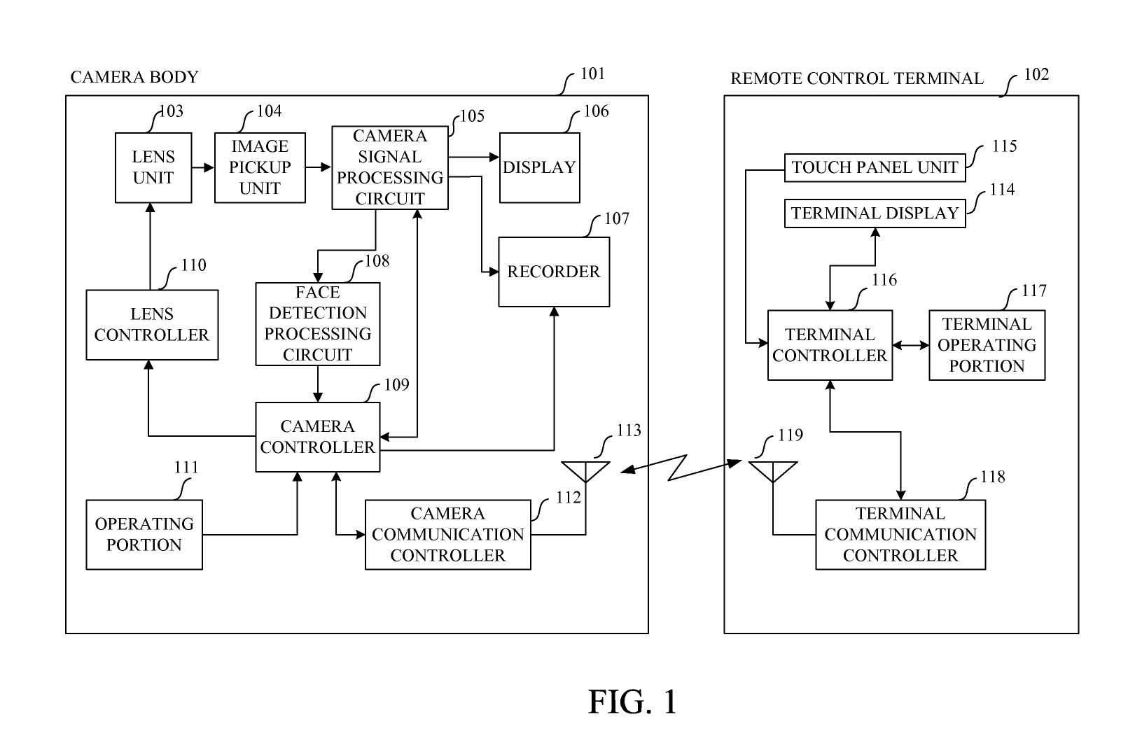

FIG. 1 illustrates a block diagram of a configuration of a digital video camera (hereinafter, referred to as a camera body) and a remote control terminal (a communication apparatus) having a function to remotely (externally) operate the camera body (an image pickup apparatus), which is an embodiment of the present invention. Although a case where the camera body is a digital video camera will be described in this embodiment, the present invention can also be applied to other image pickup apparatuses such as digital still cameras.

In FIG. 1, reference numerals 101 and 102 respectively denote a camera body (an image pickup apparatus) and a remote control terminal (a communication apparatus). First, components of the camera body 101 will be described.

Reference numeral 103 denotes a lens unit that is an image pickup optical system, which is configured by including a plurality of optical lenses including a focus lens for focusing of an object image, a stop for adjusting an amount of light that passes through lenses, motors for driving the above parts, etc. In this embodiment, a configuration of an image pickup apparatus where the lens unit is integral with the camera body, so-called lens built-in type image pickup apparatus, is described as an example. However, a configuration of a lens interchangeable type image pickup apparatus such as a single-lens reflex camera, so-called interchangeable lens system, may also be adopted.

Reference numeral 104 denotes an image pickup unit, which is configured by including an image pickup element (an image pickup device) such as a CCD sensor or a CMOS sensor which performs photoelectric conversion on an object image (an optical image) via an optical system, a signal processing circuit which performs sampling, gain adjustment, and digitalization on the output from the image pickup element, etc. Reference numeral 105 denotes a camera signal processing circuit which performs various kinds of image processing on an output signal from the image pickup unit 104 and generates a video signal (an image signal). In addition, in the camera signal processing circuit 105, a focus signal used for the focusing, and a luminance signal used for exposure adjustment are generated based on the image signal of the after-mentioned AF region and AE region which are set by the camera controller 109 to be output to the camera controller 109.

Reference numeral 106 denotes a display which displays the image signal from the camera signal processing circuit 105, and reference numeral 107 denotes a recorder which records the image signal from the camera signal processing circuit 105 on a storage medium such as a magnetic tape, an optical disk, a semiconductor memory, etc.

Reference numeral 108 denotes a face detection processing circuit (an object detector) which performs a known face detection process on the image signal from the camera signal processing circuit 105 and detects a position and a size of a face region of a person (an object region) in a shot image screen. As for a known face detection process, for example, a method of detecting a face by a matching level with a face contour plate which is prepared in advance by extracting a skin color region from tone color of pixels represented in image data is known. Further, for example, a method of performing pattern recognition using a feature point in a face such as eyes, nose, mouth, etc., which are extracted is also known.

The face detection processing circuit 108 outputs the detection result to the camera controller 109. The camera controller 109 is a microcomputer which controls the camera body 101 on the basis of a control program. The camera controller 109 executes various kinds of controls of the camera body 101 in this embodiment, as described hereinafter. A memory such as a flash ROM or a DRAM, which is not shown, is connected to the camera controller 109 to store the control program and data therein. In such a way, the camera controller (controller) 109 can perform an image pickup control (an AF control (automatic focus control), an AE control (an automatic exposure control), AWB control, etc.) with respect to an object which is detected in the face detection processing circuit 108. Moreover, the camera controller (tracker) 109 can track the position of the detected object even if the object moves and the AF and AE controls can be performed accurately with respect to the moving object by moving the AF and AE control region according to the moved object position, for example.

Reference numeral 110 denotes a lens controller, which controls the motors of the lens unit 103 based on control signals output from the camera controller 109 to drive the focus lens and the stop. Reference numeral 111 denotes an operating portion which is configured with an operation key, a touch panel, etc., and the operating portion is used when a user performs recording, replaying of recorded images, various setting, etc. by operating the camera body 101 and the operation signal is output to the camera controller 109.

Reference numeral 112 denotes a camera communication controller which controls communication for sending and receiving image data (a moving image or a video) and control data with the remote control terminal 102. As for the communication, wireless communication such as wireless LAN, mobile phone lines, etc. may be used or cabled communication such as cabled LAN, etc. may be used. Reference numeral 113 denotes a communicator (a first communicator) which is used for wireless communication, and the communicator 113 may be an antenna for inputting and outputting radio signals.

Next, components of the remote control terminal 102 will be described. Reference numeral 114 denotes a terminal display which displays image data received from the camera body 101, various kinds of setting data, and the like, and the terminal display 114 is configured with a liquid crystal display apparatus (LCD) or the like. The touch panel unit 115 is arranged so as to overlap a display surface of the terminal display 114 and outputs coordinate information (operation information) when a user touches on the touch panel to the after-mentioned terminal controller 116.

The terminal controller 116 is a microcomputer which integrally controls the remote control terminal 102 on the basis of a control program stored in a memory or the like which is not shown. The terminal controller 116 executes various kinds of controls of the remote control terminal 102 in this embodiment, as described hereinafter. Here, a memory such as a flash ROM or a DRAM, which is not shown, for storing the control program and data is also connected to the terminal controller 116.

Reference numeral 117 denotes a terminal operating portion which is configured with an operation key, etc. and the terminal operating portion 117 is used when a user performs various kinds of setting and the like by operating the remote control terminal 102 and outputs an operation signal to the terminal controller 116. When the terminal operating portion 117 is provided with an arrow key and an OK key for selecting an operation menu and specifying a screen region in the terminal display 114, the touch panel unit 115 may also be omitted.

Reference numeral 118 denotes a terminal communication controller which controls communication for sending and receiving image data and control data with the camera body 101. Reference numeral 119 denotes a communicator (a second communicator) which is used for wireless communication, and the communicator 119 may be an antenna for inputting and outputting radio signals.

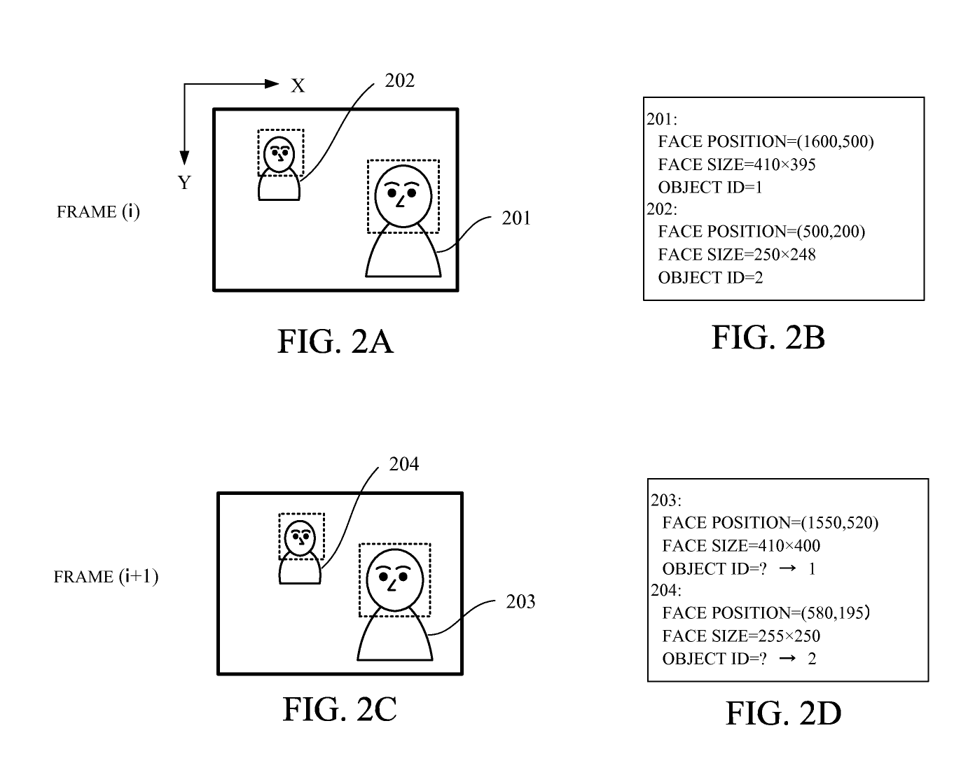

Next, detection of an object (a face), a setting of identification information, and a control of tracking the object, which are performed by the camera body 101, will be described with reference to FIGS. 2A to 2D.

FIG. 2A is a video frame (denoted as frame (i)) which is picked up in the camera body 101 at a certain time, and person images 201 and 202 are picked up in a screen. Here, it is assumed that the person images 201 and 202 are picked up for the first time in this screen. FIG. 2B illustrates a result of face detection by the face detection processing circuit 108 in the image (in the screen) of FIG. 2A, and the positions (face positions) in the screen and the sizes (face sizes) of the faces of the person images 201 and 202 are detected. The face positions and the face sizes are represented in pixel units in a coordinate system where a horizontal axis in the screen is an X axis and a vertical axis in the screen is a Y axis. The frames of dotted lines in the screen of FIG. 2A indicate the positions and the sizes of the faces which are detected by the face detection processing circuit 108 to be superimposed on the image. These detection results are output to the camera controller 109 as described above, and the camera controller 109 (an identification information generator) sets (generates) object IDs which are identification information of the detected objects. Because the person images 201 and 202 are detected in the frame (i) for the first time as described above, the object IDs=1 and 2 are set and the IDs are stored in a memory, which is not shown, along with the face positions and the face sizes.

FIG. 2C is the next frame of the frame (i) (denoted as frame (i+1)), and person images 203 and 204 are being picked up. The person images 203 and 204 are same persons as the person images 201 and 202, however, their positions and sizes have slightly changed because they are moving. FIG. 2D illustrates the results of face detection with respect to this image. Here, the frame (i+1) and the frame (i) do not have to be continuous and the interval therebetween may be a number of frames according to the processing ability of the face detection processing circuit 108. These detection results are also output to the camera controller 109, and the camera controller 109 compares them to the data of the person images 201 and 202 which is the latest detection results.

By comparing the data of the face positions and the face sizes of the person images 201 and 202 to the data of the face positions and the face sizes of the person images 203 and 204, it is recognized that the data of the person image 203 is close to that of the person image 201. Further, it is recognized that the data of the person image 204 is close to that of the person image 202. Therefore, it is determined that the person images 203 and 201 are of the same person and the same object ID as that of the person image 201, which is ID=1, is reset for the person image 203. Similarly, it is determined that the person images 204 and 202 are of the same person and the same object ID as that of the person image 202, which is ID=2, is reset for the person image 204. By repeating the above process with respect to the frames hereafter, the same object ID can be set for the same object even if the object is moving and its position can be tracked.

If, for example, the object having ID=2 moves outside of the screen during tracking and its face cannot be detected, ID=2 will be set as vacant because there is no object which is intended for ID=2. If a new object came in to the screen, a new object ID (for example, ID=3) is set so that the object ID does not overlap with other objects in the screen which were there from before. If a new object comes in in a state where ID=2 is vacant, overlapping does not occur as the vacant ID=2 is allocated. However, when there is a communication delay between the camera body and the remote control terminal, the object IDs may not match between the camera body and the remote control terminal. Therefore, it is preferable that ID=2 remains vacant during the time corresponding to at least to the communication delay.

As described above, even if a plurality of objects (faces) exist on the screen, individual objects can be identified by the object IDs which the camera controller 109 allocates as their identification information. Further, by comparing the face detection results of continuous video frames, whether the object is the same or not can be determined even if the object (face) is moving in the screen and the position of each object can be tracked. Furthermore, by controlling so that the setting of the AF region and the AE region with respect to the camera signal processing circuit 105 is updated in a way that the position of the tracked object is always to be the target for the AF and AE controls, the AF and AE control region can be moved in conformity with the moving object. Here, detailed algorithms are omitted because they are well known.

Although data of the face position and the face size are used for tracking an object in the above description, either one may be used or other detection data may be used together. For example, in recent years, a face recognition function which compares an image shot by the camera to the face features of a specific person which are registered in advance to identify the face of the specific person and not only detecting persons' faces in an image has been put to practical use. In a case of a camera equipped with such function, the position of an object can be tracked by using the face recognition function and not by the resemblance of the face positions and the face sizes between frames as described above. Further, in a case where the object having ID=2 moves out of the screen and comes back in to the screen again, for example, if the objects can be determined that they are the same person by the face recognition function, the previously set ID=2 is set instead of setting a new ID. In such way, the object can be continued to be tracked even if the object goes in and out of the screen.

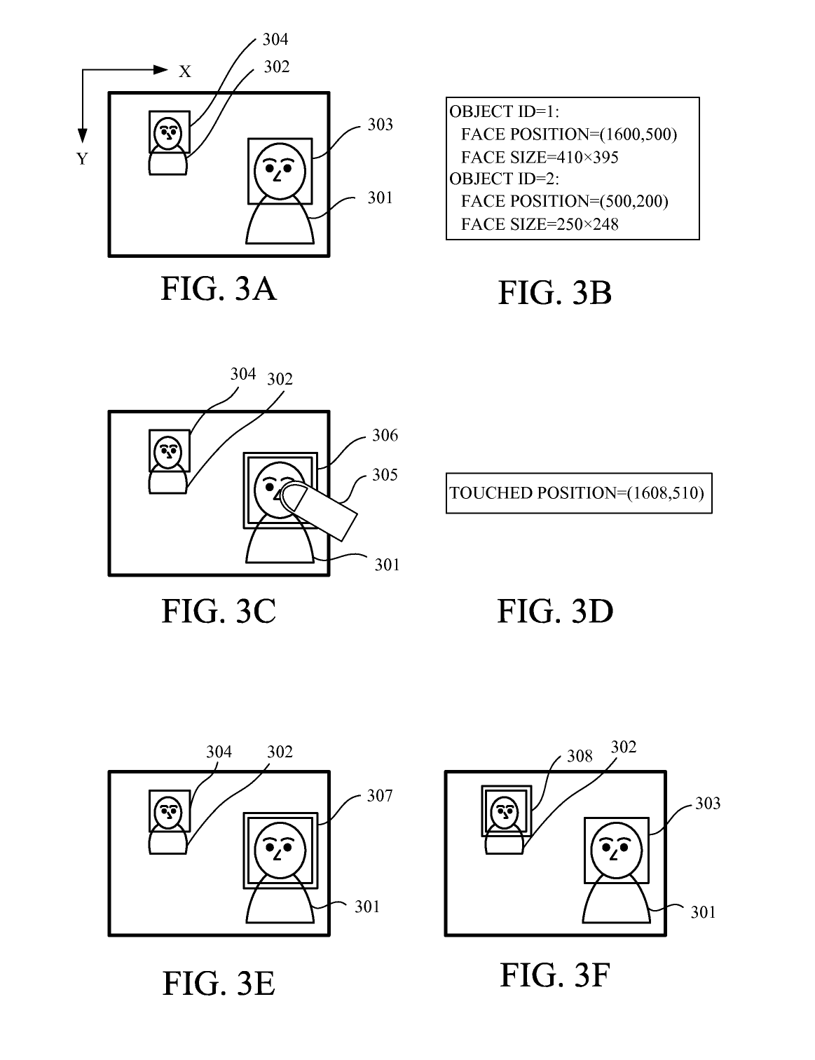

Next, a process of determining identification information of an object which is selected by a user in the remote control terminal 102 will be described with reference to FIGS. 3A to 3F.

FIG. 3A is a displayed image in the terminal display 114 of the remote control terminal 102 at a certain time, and an image corresponding to the image signal received from the camera body 101 is displayed. FIG. 3B illustrates data of object IDs (object identification information), face positions (position information of the objects) and face sizes (size information of the objects) which are received in an approximately synchronized manner with the image which is displayed in FIG. 3A. The face positions and the face sizes are indicated in pixel units in a coordinate system where the horizontal axis on the screen is the X axis and the vertical axis on the screen is the Y axis. In the image of FIG. 3A, person images 301 and 302 are picked up, and they correspond to object IDs=1 and 2, respectively. The frame displays (visual indications) 303 and 304 indicate face regions obtained from the data of the face positions and the face sizes illustrated in FIG. 3B, and they are displayed to be superimposed on the displayed screen.

Hereinafter, first, a process performed in a case where the remote control terminal 102 includes the touch panel unit 115 and a user specifies an object which is the target for the AF and AE controls by operating the touch panel will be described. As illustrated in FIG. 3C, a user's finger 305 touches the face portion of the object 301 in the image which is being displayed in the terminal display 114. At this time, the touched position data illustrated in FIG. 3D is output to the terminal controller 116 from the touch panel unit 115. In the terminal controller (determining portion) 116, the data of the face positions and the face sizes illustrated in FIG. 3B are compared to the touched position data illustrated in FIG. 3D and the object specified by the user is determined. Here, because the touched position data is close to the face region of the object ID=1, it is determined that the user specified the object having object ID=1. In order to notify the user that the object ID is determined, the face region of the determined object is displayed with double frame display 306 surrounding it as illustrated in FIG. 3C. Accordingly, in the remote control terminal including a touch panel, by checking the data of the face positions and the face sizes received from the camera body against the data of the touched position output from the touch panel, the identification information (object ID) of the object which is specified by the user can be determined. Because checking against the touched position data can be performed with the face position data alone, the configuration may be such that face size information is not received from the camera body.

As described above, in the present embodiment, position information and identification information of the object which is being detected and tracked in the camera body are sent to the remote control terminal as well as video data. The position information and identification information can be sent later than the video data if necessary. In the remote control terminal, the position information of the object which a user specified by the touch panel is checked against the position information of the object received from the camera body to determine the identification information of the object specified by the user.

From the remote control terminal to the camera body, the identification information of the object which is specified as the target for the AF and AE controls is sent. In the camera body, which object among the objects in the screen is to be the target for the AF and AE controls is determined by using the identification information received from the remote control terminal. Because the object is being detected and tracked even during the communication delay time in the camera body, the AF and AE control region can be set to the position matching the object even if the object which is specified by the user is moving.

Next, a process performed in a case where the remote control terminal 102 does not include the touch panel unit 115 and a user specifies an object which is the target for the AF and AE controls only by the terminal operating portion 117 will be described. FIGS. 3A and 3B are as described above. In the terminal operating portion 117 of the remote control terminal 102, at least two types of keys (switches), which are a selection key (object selection portion) for selecting an object and an OK key (object deciding portion) for determining an object, are included. If a user pushes the selection key, the operation information is output to the terminal controller 116. The terminal controller 116 controls the terminal display 114 to display the frame display indicating the face region having the object ID=1 by using the double frame 307 as illustrated in FIG. 3E. If the user pushes the selection key again, the face region having the object ID=2 is to be displayed with the double frame 308 as illustrated in FIG. 3F. By controlling the display as described above, the object to be displayed with the double frame in the screen is switched every time a user pushes the selection key. Therefore, a user can select the object which is to be the target for the AF and AE controls from a plurality of objects. Then, if the OK key is pushed in a state where the object which the user intends to specify is displayed with the double frame, the operation information is output to the terminal controller 116. In this way, the terminal controller 116 can detect that the object which is displayed with the double frame at that time is determined as the object target for the control. Therefore, the identification information (object ID) of the object specified by the user can be determined. If the display size of the frame is fixed, the above described display control can be performed only with the face position data alone. Thus, the configuration may be such that the face size information is not received from the camera body.

In specifying a target for the AF and AE controls through the above described touch panel operation, it can be configured so that a position in the screen and not an object (face) is specified as the target for the AF and AE controls if touching is performed on a screen where no face is picked up. Further, it may be configured so that a position in the screen and not an object (face) is specified as the target for the AF and AE controls if a user touches a position other than a face region of an object. That is, in a case where it is determined that an object (face) does not exist at the position touched by a user in the terminal controller 116, it may be specified to the camera body so as to set the AF and AE control region on the basis of the position information of where was touched, similar to the conventional art. Processes performed in such case will be described in detail below.

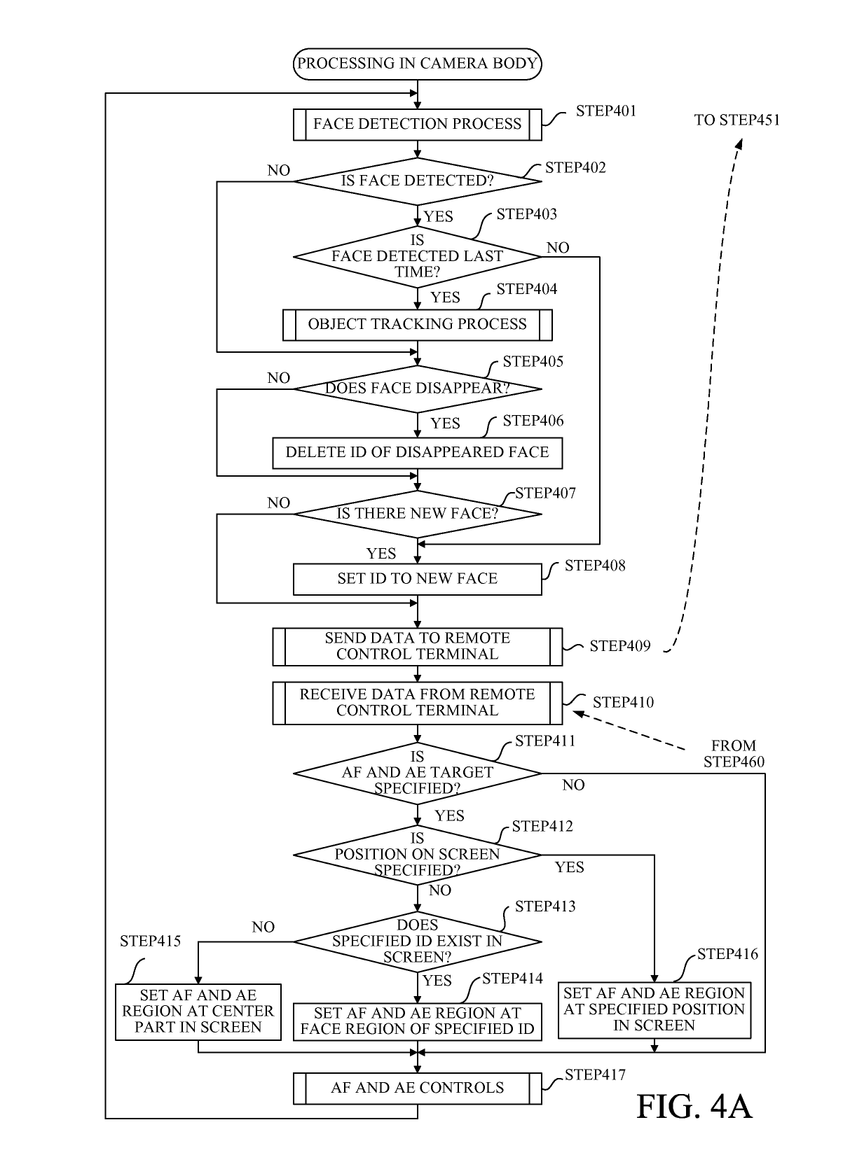

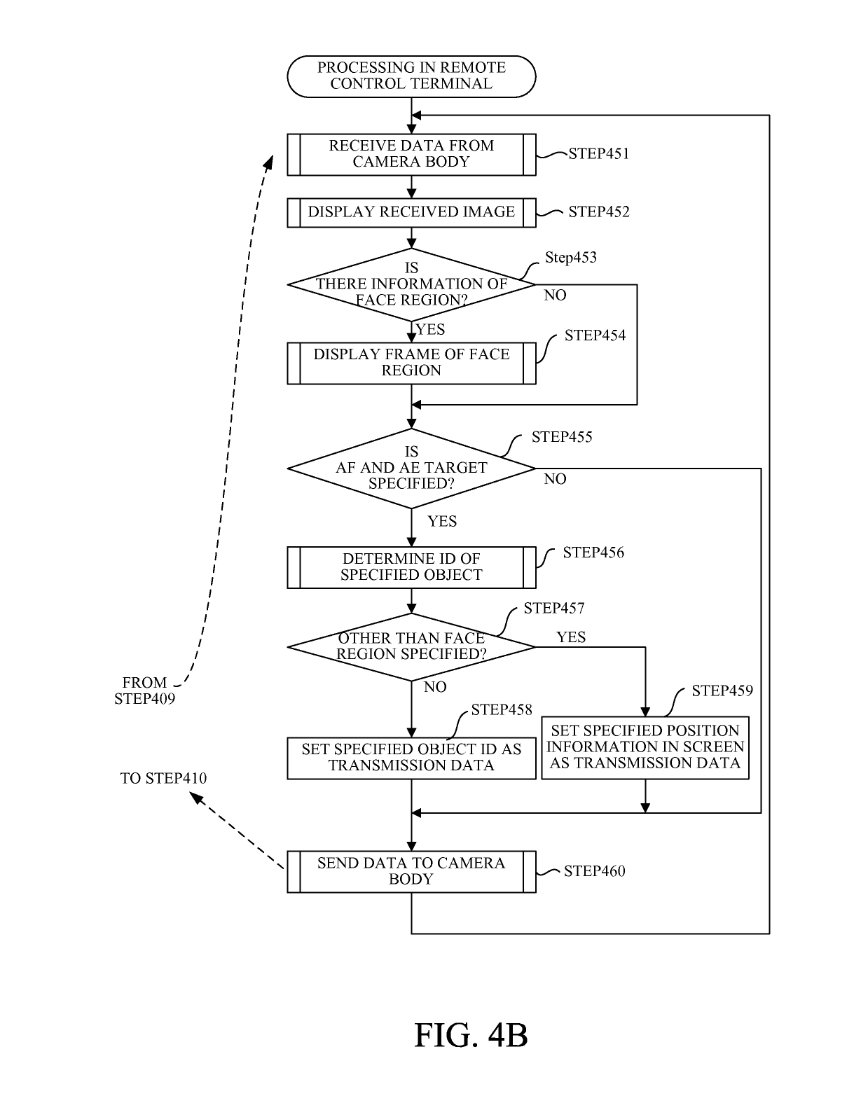

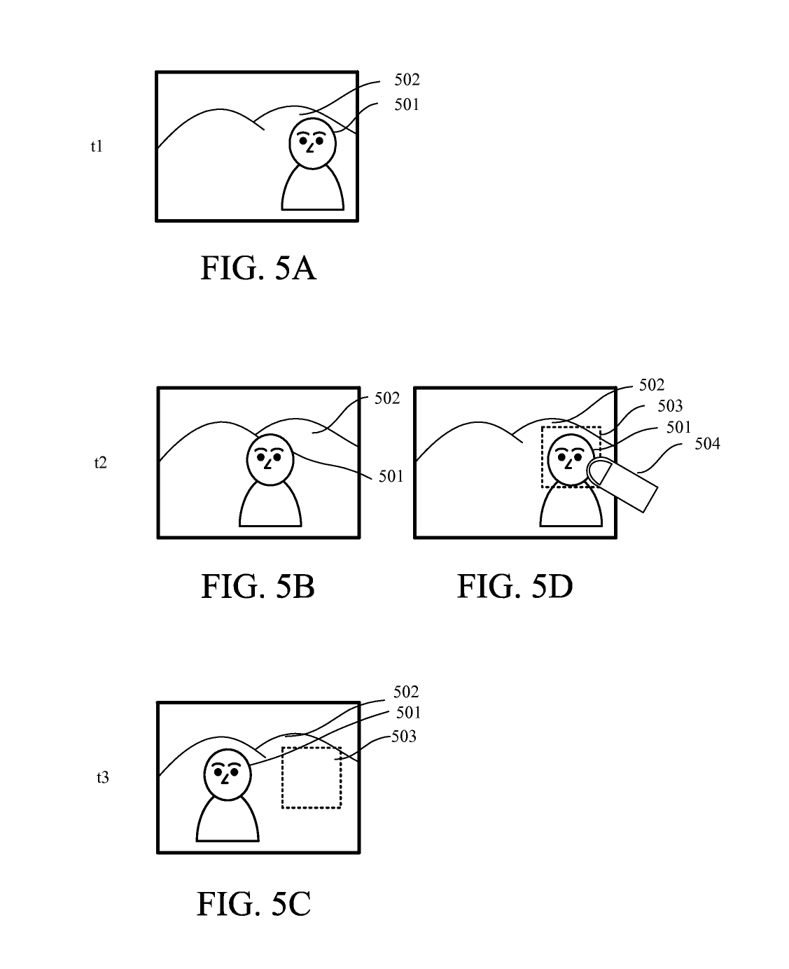

Next, a process of a user specifying the AF and AE control region through communication between the camera body and the remote control terminal will be described by using the flowcharts of FIGS. 4A and 4B. In a remote control system of a general camera, various kinds of operations such as starting and ending of shooting an image (image pickup), setting of camera operation conditions, replaying of recorded images, etc. can be performed. However, descriptions on processes relating to these operations are omitted, and the following description is limited to the processing for specifying the AF and AE control region. Further, it is assumed that the camera body and the remote control terminal are operating in a mode for executing a remote control and that the communication is established already. A description of a known control such as the initial control for establishing the communication is also omitted.

First, processes which are executed in the camera body 101 will be described. These processes are executed in a repeated manner by the camera controller 109 every time the frame of a shot image (picked-up image) is updated, for example. In step 401, the above described known face detection process is executed on an image signal output from the camera signal processing circuit 105. Next, in step 402, whether a face is detected based on the image signal is determined. If it is determined that a face is not detected, the processing proceeds to step 405 because the tracking process will not be executed. If it is determined that a face is detected, the processing proceeds to step 403 and whether a face was detected in the last processing is determined. If it is determined that a face was not detected in the last processing, the processing proceeds to step 408 because the tracking process will not be executed and an object ID is set with respect to the newly detected face. On the other hand, if it is determined that a face was detected in the last processing, the processing proceeds to step 404 and the object tracking process described with reference to FIGS. 2A to 2D is executed.

Next, in step 405, whether there is a face which disappeared from the screen due to moving outside of the screen or the like among the faces detected in the last processing is determined. If it is determined that none of the faces disappeared, the processing proceeds to step 407. On the other hand, if it is determined that there is a face that disappeared, the processing proceeds to step 406 and the object ID of the face which has disappeared is set as a vacant ID as described above and the processing proceeds to step 407. In step 407, whether a new face which was not in the screen during the last processing is detected is determined. If it is determined that there is no new face, the processing proceeds to step 409. On the other hand, if it is determined that there is a new face, the processing proceeds to step 408 and an ID which does not overlap with the object IDs of the already detected faces is to be set with respect to the newly detected face. As described above, if there is an object ID which is vacant, this object ID remains vacant at least for the time corresponding to a communication delay and an ID which does not overlap with the already existing IDs including the vacant ID is set with respect to the newly detected face.

Next, in step 409, the shot image data which is shot by the camera body 101 and the object IDs and data of the face positions and the face sizes detected based on the image are sent to the remote control terminal 102 as described above.

Next, in step 410, various kinds of control data which are sent from the remote control terminal 102 are received and the content of the data is analyzed. Then, in step 411, whether control information to specify a target region for the AF and AE controls (an AF and AE region) is included in the received data is determined. If it is determined that the control information relating to the AF and AE region is not included, the AF and AE region does not need to be changed from the last setting. Therefore, the processing proceeds to step 417 and the AF control and AE control are executed, and then, the processing returns to step 401 and switches to the next processing. On the other hand, if it is determined that the control information relating to the AF and AE region is included, the processing proceeds to step 412.

In step 412, whether an object ID is specified or position information on the screen is specified as a target region for the AF and AE controls is determined. As described below, because the remote control terminal 102 sends the position information of the touched region instead of the object ID to the camera body 101 if a user touches a position other than the face regions, it is determined which information is sent in the embodiment. If it is determined that position information on the screen is specified, the processing proceeds to step 416 and the AF region and the AE region are set for the camera signal processing circuit 105 so that the position specified on the screen becomes the target for the AF and AE controls. In this way, the camera can be controlled so as to set the AF and AE control region on the basis of the touched position similar to the conventional art when a user touches a position other than face regions as described above. In the embodiment, the AF and AE control region is fixedly set to the position on the screen which is received through communication as an example. However, objects of the image at a position in the received screen may be detected, and the AF and AE control region may be tracked by tracking the object image which was at the position by a known art such as performing pattern matching with respect to images thereafter.

On the other hand, in step 412, if it is determined that the object ID is specified as the target region for the AF and AE controls, the processing proceeds to step 413. In step 413, whether the object region corresponding to the specified object ID currently exists in the screen is determined. As described above, the communication delay occurs between the camera body 101 and the remote control terminal 102, and therefore the object corresponding to the specified object ID may have disappeared due to moving outside of the screen during the communication delay. In this case, because there is no target to be set as the AF and AE region, it is determined that the target object does not exist (has disappeared) in step 413 and the processing proceeds to step 415, and then, the AF and AE region is set at the center part in the screen. Here, if there are objects (faces) other than the specified object in the screen, the AF and AE region may be set to another face region in the screen instead of the center of the screen. Although it is not illustrated in the flowchart of FIG. 4A, if a target object does not exist, information indicating this condition may be sent to the remote control terminal 102. In such a case, a warning indicating that the AF and AE region cannot be set to the specified object to a user may be displayed in the remote control terminal, for example.

If it is determined that the object region corresponding to the specified object ID currently exists in the screen in step 413, the processing proceeds to step 414 and the AF and AE region is set to the object region corresponding to the specified object ID. With respect to the object region corresponding to the object ID, its position is being tracked by the above described object tracking process of step 404 even when the object is moving. Therefore, the AF and AE control region can be set correctly even if the communication delay occurs.

Also in the case where any process of steps 414, step 415 and step 416 is executed, the processing proceeds to step 417 and the AF controls and the AE controls are executed, and then, the processing returns to step 401 and switches to the next processing.

Next, processing which is executed in the remote control terminal 102 will be described. This processing is executed in a repeated manner by the terminal controller 116 every time the received data from the camera body 101 is updated, for example. In step 451, shot image data and various control data sent from the camera body 101 are received and the content of the data is analyzed. If a face is included in the image data, the above-described object ID and data of face position and face size are also included in the received data.

Next, in step 452, the image corresponding to the image data received from the camera body 101 is displayed in the terminal display 114. Then, in step 453, whether an object ID and data of the face position and the face size are included in the received data is determined. If it is determined that the object ID and the data of the face position and the face size are not included, the processing proceeds to step 455. If it is determined that the object ID and the data of the face position and the face size are included, the processing proceeds to step 454. In step 454, the frame display indicating the face region is displayed to be superimposed on the image data as described with reference to FIG. 3C by using the received data of the face position and the face size and the processing proceeds to step 455.

In step 455, whether a user specified the target region for the AF and AE controls is determined. In particular, whether the target region is determined by touching the touch panel as described with reference to FIG. 3C or by the OK key is determined. If it is determined that the target region for the AF and AE controls is not specified, the processing proceeds to step 460 and various control data are sent to the camera body 101. However, in such a case, because the target region for the AF and AE controls is not specified, control information for specifying the target region for the AF and AE controls is not included in the transmission data. Thereafter, the processing returns to step 451 and switches to the next processing.

On the other hand, if it is determined that a target region for the AF and AE controls is specified in step 455, the processing proceeds to step 456 and executes a process for determining the identification information (object ID) of the object described with reference to FIGS. 3A to 3D.

Next, in step 457, whether a user touched a position other than the face region is determined. If it is determined that a position other than the face region is touched, the processing proceeds to step 459 and the position information (operation information) in the screen where specified by touching is detected, and this position information is set as the transmission data to be sent to the camera body 101. In this way, as described in step 412 and step 416, the camera body 101 can be controlled so as to set the AF and AE control region on the basis of the touched position information, similarly as in the conventional art in a case where a user touched a position other than the face region. After setting the position information as the transmission data in step 459, the processing proceeds to step 460 and data including the position information and the control information which specifies the target region for the AF and AE controls is sent to the camera body 101. Thereafter, the processing returns to step 451 and switches to the next processing.

If it is determined that a user specified the face region in step 457, the processing proceeds to step 458 and the object ID which is specified by a user is set as the transmission data. Then, in step 460, data including the object ID and the control information which specifies the target region for the AF and AE controls is sent to the camera body 101. In this way, because the AF and AE control region is set to the object region corresponding to the specified object ID in the camera body 101 as described above in step 414, the AF and AE control region is set correctly even if the communication delay occurs. Thereafter, the processing returns to step 451 and switches to the next processing.

As described above, according to the present embodiment, if a user specifies the face region, the identification information of the object specified as the target for the AF and AE controls is sent to the camera body from the remote control terminal instead of the position information of the target region for the AF and AE controls as in the conventional art. Then, with the identification information received from the remote control terminal and the detection and tracking information of the object during the communication delay, the AF and AE control region is set to the position of the object which is specified as the target for the AF and AE controls in the camera body. By having such configuration, even if the communication delay occurs between the camera body and the remote control terminal, the AF and AE control region can be set correctly with respect to a moving object.

In the above description, the detector of the object is configured to detect a person's face. However, a detector which detects parts other than a person's face such as a body may also be used as long as a position of an object region included in an image can be executed. Further, for example, a detector which detects an object other than a person by detecting a region of a specific color or pattern may also be used.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions. Parts of the above described embodiment may be combined arbitrarily.

### Other Embodiments

The object of the present invention can also be achieved as described below. That is, a storage medium in which program code of software describing the procedure for realizing the functions of the above described embodiment is to be supplied to an image pickup apparatus and a remote control terminal. Then, a computer (or a CPU, a MPU, etc.) of the image pickup apparatus and the remote control terminal reads the program code stored in the storage medium and executes the program codes.

In this case, the program code itself which is read from the storage medium realizes the new functions of the present invention, and the storage medium on which the program code is stored and the program constitute the present invention.

As for the storage medium for supplying the program code, for example, a flexible disk, a hard disk, an optical disk, a magnet-optical disk, etc. are suggested. Further, CD-ROM, CD-R, CD-RW, DVD-ROM, DVD-RAM, DVD-RW, DVD-R, an electromagnetic tape, a non-volatile memory card, ROM, etc. may also be used.

A program embodying the present invention may be carried on or by a carrier medium other than a storage or recording medium. For example, the carrier medium may be a transmission medium such a signal. In this case, the program may be supplied by transmission in the form of a signal through a network (downloading or uploading). The network may be the Internet. A program embodying the present invention may, in particular, be an app downloaded from an app store such as ITunes (a registered trade mark of Apple Corp.) or Google Play.

Moreover, by allowing the program code which the computer reads to be executed, the functions of the above described embodiment are realized. Also, the present invention includes a case where a part of or all of the actual processing is performed by the OS (operating system) which is running on the computer, for example, on the basis of the commands given by the program code and the functions of the above described embodiment are realized through such processing.

Further, the present invention includes the following case. The program code is read from the storage medium first, and the program code is written on a memory provided in an expansion board inserted in the computer or in an expansion unit which is connected with the computer. Thereafter, on the basis of commands of the program code, a part of or all of the actual processing is performed by the CPU provided in the expansion board or the expansion unit, for example.

According to the present invention, an image pickup apparatus, a communication apparatus, a method of controlling the image pickup apparatus, and a method of controlling the communication apparatus which are advantageous to an image pickup control even when a communication delay occurs between the image pickup apparatus and the communication apparatus can be provided.

This application claims the benefit of Japanese Patent Application No. 2013-005840, filed on Jan. 17, 2013, which is hereby incorporated by reference herein in its entirety.

What is claimed is:

1. An image pickup apparatus, adapted to be used with remote control apparatus external to the image pickup apparatus, the image pickup apparatus comprising:
an image pickup device configured to generate an image signal by performing photoelectric conversion on an optical image;
an object detector configured to detect a plurality of objects based on the image signal generated by the image pickup device;
an identification information generator configured to allocate identification information to each of the objects detected by the object detector;
a communicator operable to send the image signal or another signal generated by the image pickup device and the identification information allocated to each of the objects by the identification information generator to the remote control apparatus, and also operable to receive identification information of an object specified by a user from among the objects for which identification information has been sent to the remote control apparatus; and
a controller operable, based on the received identification information, to specify a target object among the objects detected by the object detector.

2. The image pickup apparatus according to claim 1,
wherein the received identification information of the object specified by the user is the same as the identification information of one of the detected objects as sent from the remote control apparatus.

3. The image pickup apparatus according to claim 1,
wherein the communicator is operable to receive identification information of the target object specified in an image displayed on a display of the remote control apparatus based on the image signal sent to the remote control apparatus by the image pickup apparatus.

4. The image pickup apparatus according to claim 1,
wherein the controller means is operable to track the specified target object.

5. The image pickup apparatus according to claim 1,
wherein the communicator is operable to also send to the remote control apparatus position information of the objects detected by the object detector, and identification information allocated to each of the objects by the identification information generator.

6. The image pickup apparatus according to claim 1,
wherein the controller is operable to perform at least one of an automatic focus control and an automatic exposure control based on the received identification information.

7. The image pickup apparatus according to claim 1,
wherein
the object detector is operable to detect position information of the objects and size information of the objects, and
the communicator is operable to send position information of the detected objects and size information of the detected objects.

8. A remote control apparatus, adapted to be used with an image pickup apparatus external to the remote control apparatus, the remote control apparatus comprising:
a communicator operable to receive an image signal representing an image picked up by the image pickup apparatus and identification information allocated by the image pickup apparatus to each of a plurality of objects detected in the image;
a display unit configured to display an image based on the received image signal; and
a controller configured to provide identification information of a target object specified by a user of the remote control apparatus based on the displayed image from among the objects for which identification information has been received by the communicator;
wherein the communicator is further operable to send the identification information of the target object provided by the controller.

9. The remote control apparatus according to claim 8,
wherein the controller further comprises:
a specifying portion operable to specify the target object and position information based on the displayed image; and
a determining portion operable to determine identification information for the target object based on the displayed image from among the objects for which identification information has been received by the communicator.

10. The remote control apparatus according to claim 8,
wherein the image picked up by an image pickup device is displayed with a delay with respect to the picking up of the image.

11. The remote control apparatus according to claim 8,
wherein the target object is an object which is specified by a user with respect to the image displayed on the display unit of the remote control apparatus.

12. The remote control apparatus according to claim 8,
wherein the communicator is operable to receive the image signal and the identification information allocated by the image pickup apparatus to each of a plurality of objects detected in the image.

13. The remote control apparatus according to claim 8,
wherein
the communicator is further operable to receive from the image pickup apparatus position information of each detected object, and
the controller is operable to determine the identification information of the target object based on the received position information and identification information of each object.

14. The remote control apparatus according to claim 9,
wherein the identification information of the target object determined by the determining portion of the controller is used when performing image pickup control of the target object in the image pickup apparatus.

15. The remote control apparatus according to claim 8,
wherein the display unit displays a visual indication at a position of at least one said object when the image based on the received image signal is displayed.

16. A method of controlling an image pickup apparatus adapted to be used with remote control apparatus external to the image pickup apparatus, the method comprising:
an image signal generating step of generating an image signal by performing photoelectric conversion on an optical image;
an object detecting step of detecting a plurality of objects based on the image signal generated in the image signal generating step;
an identification information generating step of allocating identification information to each of the objects detected in the object detecting step;
a sending step of sending the image signal or another signal generated by an image pickup device and the identification information allocated to each of the objects in the identification information generating step to the remote control apparatus;
a receiving step of receiving identification information of a target object specified by a user from among the objects for which identification information has been sent to the remote control apparatus; and
a specifying step of specifying, based on the received identification information, a target object among the objects detected in the object detecting step.

17. The method of controlling the image pickup apparatus according to claim 16,
wherein the received identification information of the object specified by the user is the same as the identification information of one of the detected objects as sent from the remote control apparatus.

18. The method of controlling the image pickup apparatus according to claim 16,
wherein the receiving step comprises receiving identification information of the target object specified in an image displayed on a display unit of the remote control apparatus.

19. The method of controlling the image pickup apparatus according to claim 16,
further comprising tracking the specified target object.

20. The method of controlling the image pickup apparatus according to claim 16,
wherein the sending step comprises sending to the remote control apparatus position information of the objects detected in the object detecting step, and identification information allocated to each of the objects in the identification information generating step.

21. The method of controlling the image pickup apparatus according to claim 16, further comprising a controlling step of performing at least one of automatic focus control and automatic exposure control based on the received identification information.

22. The method of controlling the image pickup apparatus according to claim 16,
wherein
positions of the objects and sizes of the objects are detected in the object detecting step, and
position information of the detected objects and size information of the detected objects are sent in the sending step.

23. A method of controlling a remote control apparatus adapted to be used with remote control apparatus external to the image pickup apparatus, the method comprising:
a receiving step of receiving an image signal representing an image picked up by the image pickup apparatus and identification information allocated by the image pickup apparatus to each of a plurality of objects detected in the image;
a displaying step of displaying an image based on the received image signal;
a controlling step of providing identification information of a target object specified by a user of the remote control apparatus based on the displayed image from among the objects for which identification information has been received in the receiving step; and
a sending step of sending the identification information of the target object provided by the controlling step.

24. The method of controlling the remote control apparatus according to claim 23,
wherein the controlling step further comprises:
a specifying step of specifying the target object and position information based on the displayed image; and
a determining step of determining identification information of the target object based on the displayed image from among the objects for which identification information has been received.

25. The method of controlling the remote control apparatus according to claim 23,
wherein the image picked up by the image pickup apparatus is displayed in the displaying step with a delay with respect to the picking up of the image.

26. The method of controlling the remote control apparatus according to claim 23,
wherein the target object is an object which is specified by a user with respect to the image displayed by the remote control apparatus in the displaying step.

27. The method of controlling the remote control apparatus according to claim 23,
wherein the receiving step comprises receiving the image signal and the identification information allocated by the image pickup apparatus to each of a plurality of objects detected in the image.

28. The method of controlling the remote control apparatus according to claim 23,
wherein
the receiving step further comprises receiving from the image pickup apparatus position information of each detected object, and
the controlling step further comprises determining identification information of the target object based on the received position information and identification information of each object.

29. The method of controlling the remote control apparatus according to claim 24,
wherein the identification information of the target object determined in the controlling step is used when performing image pickup control of the target object in the image pickup apparatus.

30. The method of controlling the remote control apparatus according to claim 23,
wherein the displaying step further comprises displaying a visual indication at a position of at least one said object when the image based on the received image signal is displayed.
